(19) United States
(12) Patent Application Publication
(10) Pub. No.: US 2011/0025444 A1
(43) Pub. Date: Feb. 3, 2011

(54) MAGNETIC CORE FOR A COIL DEVICE AND METHOD FOR MANUFACTURING A MAGNETIC CORE

(75) Inventors: Masaki Sugiyama, Aichi-ken (JP); Toshiya Yamaguchi, Aichi-ken (JP); Tomonori Inuzuka, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/933,256

(22) PCT Filed: Mar. 16, 2009
(86) PCT No.: PCT/IB09/05071

§ 371 Date: Sep. 17, 2010

(30) Foreign Application Priority Data
Mar. 17, 2008 (JP) 2008-067835

(51) Int. Cl. H01F 27/255

(52) U.S. Cl. 336/212

(57) ABSTRACT

A reactor core, which has a pair of press surfaces (a-b planar surfaces) formed by compression molding with an edge part of each of the press surfaces being plastically formed by pressure treatment, is disposed in a direction in which a magnetic flux generated upon energization of a coil does not penetrate each of the press surfaces.

### BACKGROUND OF THE INVENTION

1. Field of the Invention

This invention relates to a reactor device used in a motor for driving a hybrid vehicle or an electric vehicle, and to a method for manufacturing such a reactor device.

2. Description of the Related Art

The reactor device disclosed in, for example, Japanese Patent Application Publication No. 2004-095570 (JP-A-2004-095570) in which a plurality of gaps are inserted into a stacked core having thin silicon steel plates is known. In this reactor device, the plurality of gaps are spread and inserted into the core because the magnetic permeability of the core needs to be lowered so that the core does not easily saturate magnetically.

The problem, however, is that the stacked core is expensive. Meanwhile, a core made of a powder magnet has received attention in recent years due to significantly improved magnetic properties of a soft magnetic material obtained by a powder metallurgical method. The powder magnetic core is produced by insulating magnetic powders of approximately 100 μm one by one, mixing a small amount of organic binder therewith, and then performing compression molding and heat treatment on the obtained mixture.

However, the heat treatment has to be carried out at temperature at which the insulator and binder are not decomposed, and densification of the powder magnetic core into a sintered magnetic substance or the like cannot be expected. Therefore, the powder magnetic core is densified by performing high-pressure compression molding on it. However, high-pressure compression molding inevitably generates burrs. Burrs in the reactor might damage the insulation-coating film of the coil when winding the coil. The burrs might also damage the jigs and molds during the reactor assembly process, and might also change the length of the gaps due to fall of the powders from an edge part.

Therefore, the burrs can be removed by a cutting operation. However, if the powders are spherical like atomized powder, the powders do not entangle with one another and fall easily during a deburring operation. For this reason, in the case where deburring surfaces (press surfaces) of the reactor core are faced each other and the gaps are inserted therebetween, the length of the gaps is changed, which eventually causes reactor loss.

On the other hand, Japanese Patent Application Publication No. 2005-226152 (JP-A-2005-226152) discloses how pressure molding and plastic forming are performed on an obtained green compact to modify the outer shape thereof. Because burrs are not generated in the reactor manufactured by this method, the above-described problems can be avoided. In this reactor core, however, when gaps are inserted between the facing surface that are subjected to plastic forming, the section where powders are metallurgically bonded with one another by the plastic forming is present in the form of a ring. As a result, eddy current flows in a direction along a magnetic path cross section, which is a direction perpendicular to a direction in which the magnetic flux penetrates. Consequently, the reactor loss is increased.

Moreover, Japanese Patent Application Publication No. H5-326240 (JP-A-H5-326240) describes a method for using flat or acicular powders with magnetic anisotropy to mold a reactor while applying a magnetic field parallel to a magnetic path. According to this manufacturing method, a high-performance reactor core with high μ in which the powders are directed parallel to the magnetic field can be produced. However, this method cannot use spherical powders such as atomized powders, thereby having a low degree of freedom in selecting a raw material.

In addition, Japanese Patent Application Publication No. 2006-344867 (JP-A-2006-344867) describes a reactor that does not at all require or reduces the number of gaps by using an anisotropic nanocrystalline material as a powder material. According to this technology, use of an anisotropic nanocrystalline material can realize high magnetic anisotropy, low magnetic permeability, and low coercivity. Furthermore, this reactor is capable of using atomized powder, thereby having a high degree of freedom in selecting a raw material. However, the reactor described in this publication does not take into consideration the problems related to buns.

### SUMMARY OF THE INVENTION

This invention provides a reactor device which has a high degree of freedom in selecting a raw material and is capable of preventing burr problems and preventing the generation of eddy current, and a method for manufacturing the reactor device.

A first aspect of the invention relates to a reactor device. This reactor device has a reactor core configured by a powder magnetic core, and a coil wound around an outer periphery of the reactor core. The reactor core has a pair of press surfaces formed by compression molding. An edge part of each of the press surfaces is plastically formed by pressure treatment. The reactor core is disposed in a direction in which a magnetic flux generated upon energization of the coil does not penetrate each of the press surfaces.

In the reactor device according to the first aspect of the invention, because the edge part of each press surface is plastically formed, damage to an insulation coating film of the coil can be prevented when winding the coil. Moreover, powder can be prevented from falling and the change in the length of a gap can be prevented, by plastically forming the edge part of each press surface by means of pressure treatment.

In this reactor device, the reactor core is disposed in a direction in which the magnetic flux generated upon energization of the coil does not penetrate each press surface. Therefore, even when an edge part with low insulation property exists on each press surface as a result of the plastic forming, the generation of eddy current can be inhibited. Consequently, the increase of reactor loss can be prevented significantly.

The reactor core may have a toroidal shape and a plurality of gaps may be inserted thereto. In such a reactor device, because the press surfaces of the reactor core do not face the gaps, the generation of eddy current and the leakage of the magnetic flux caused by burrs can be prevented. As a result, a high-performance reactor device can be obtained.

The reactor core may be plastically formed by pressing a roll having a smooth surface toward the edge part.

The reactor core may be formed by chamfering the edge part by performing the plastic forming.

The width of chamfer of the reactor core may be C0.5 mm.

A second aspect of the invention relates to a method for manufacturing a reactor device. This manufacturing method relates to a reactor device that has a reactor core configured by a powder magnetic core, and a coil wound around an outer periphery of the reactor core. This manufacturing method has the steps of: plastically forming by pressure treatment an edge part of each of a pair of press surfaces of the reactor core that are formed by compression molding; and disposing the reactor core in a direction in which a magnetic flux generated upon energization of the coil does not penetrate each press surface.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a perspective view of a reactor device according to an example of the invention;

FIG. 2 is an exploded perspective view of a reactor core used in the reactor device according to the example of the invention;

FIG. 3 is an explanatory diagram showing a method for manufacturing a rectangular solid core used in the reactor device according to the example of the invention;

FIG. 4 is an explanatory diagram showing a method for molding a circular core used in the reactor device according to the example of the invention; and

FIG. 5 is a graph showing reactor loss.

### DETAILED DESCRIPTION OF EMBODIMENTS

A reactor device according to this example of the invention is configured by a reactor core configured by a powder magnetic core, and a coil wound around an outer periphery of the reactor core. Pure iron, Fe-P, Fe-Ni, Fe-Si, Fe-Al-Si or Fe-Co permendur, or Fe-Cr-Si stainless steel can be used as magnetic powder which is a raw material of the reactor core.

This reactor core can be manufactured by insulating magnetic powders one by one, mixing a small amount of organic binder therewith, and then performing compression molding. In order to insulate the magnetic powders one by one, glass, phosphate, borate, silicate, or other insulating material with high electrical resistance and good deformation compatibility can be mixed with the magnetic powders to form an insulation coating.

Compression molding can be performed by filling a molding die with the insulated magnetic powders and heating it at a molding pressure of, for example, 700 Mpa or higher. The upper limit of the molding pressure is determined in consideration of the life of the molding die. It is preferred that an inner surface of the molding die (a mold face of a cavity) be applied with a higher fatty acid lubricant. The molding is preferably performed at a temperature suitable for a reaction between the lubricant and the powders, which is, for example, 100 to 120° C.

Burrs are generated in a circumferential edge part of a press surface of the obtained green compact. In this invention, burrs are removed by performing plastic forming by means of pressure treatment, in order to prevent the burrs from falling during transportation of the green compact and damage to other parts of the green compact. The plastic forming described in JP-A-2005-226152 may be performed using a mold, to perform the pressure treatment, or a method for pressing the green compact by using a roll can also be used to perform the pressure treatment.

The coil is wound around thus obtained reactor core to obtain the reactor device. A general coil with an insulation coating film that is conventionally used can be used as the coil.

In the reactor device according to the example of the invention, the reactor core is disposed in a direction in which a magnetic flux generated upon energization of the coil does not penetrate each press surface. Therefore, even when an edge part with low insulation property exists on each press surface, the generation of eddy current can be inhibited. Consequently, the increase of reactor loss can be prevented significantly.

In addition, the coil is wound around the reactor core so as to traverse the press surfaces. Because the edge part of each press surface is subjected to the plastic forming by means of the pressure treatment and chamfered, damage to the insulation coating film of the coil can be prevented.

The reactor device according to the example of the invention is suitably used in a toroidal reactor device in which a plurality of reactor cores are provided in a row and a plurality of gaps are inserted thereto Because the magnetic permeability of the core can be adjusted freely by these gaps and the burrs on the press surfaces are chamfered, the leakage of the magnetic flux and the change in the length of the gaps that is caused by the burrs or the powders falling off the burrs can be prevented. A conventional zirconia plate or the like can be used as the gaps. The gaps and the reactor cores are adhered together by, for example, and adhesive.

The invention is described hereinafter in detail using an example, a comparative example, and a reference example.

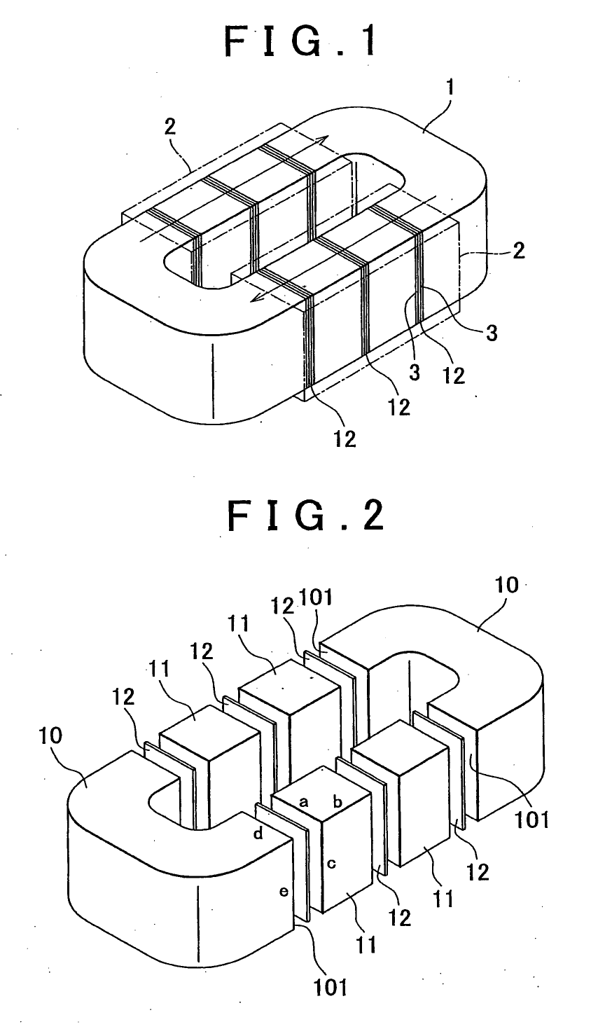

FIG. 1 shows a reactor device according to the example of the invention. This reactor device has a toroidal shape and is configured by a core 1 and a pair of coils 2 wound around an outer periphery of the core 1. This reactor device is disposed in a motor of a hybrid vehicle, wherein a magnetic flux generated upon energization of the coil 2 is directed as shown by the arrows in FIG. 1.

The core 1 is configured by two circular cores 10, four rectangular solid cores 11, and zirconia gaps 12 having a thickness of 1.6 mm, as shown in the exploded diagram of FIG. 2. Each of the circular cores 10 is formed into substantially a U shape and has a pair of leg parts 101. The pair of circular cores 10 is disposed such that the leg parts 101 of each circular core 10 face the other pair of leg parts. The two rectangular solid cores 11 are disposed in series between the facing leg parts 101. The gaps 12 are inserted between each leg part 101 of the circular core 10 and one of the rectangular solid core 11 as well as between the rectangular solid cores 11. Each leg part 101 of the circular core 10 and the gap 12 are adhered to each other by an epoxy resin adhesive layer 3. Each gap 12 and each rectangular solid core 11 also are adhered to each other by the same adhesive layer 3.

The circular cores 10 and the rectangular solid cores 11 are formed by compacting. The method for manufacturing the circular cores 10 and the rectangular solid cores 11 is described hereinbelow.

Fe-Si powder (Si: 3 mass%, average diameter: 100 μm) produced by an atomizing method is prepared as raw material powders.

A commercially-available silicone resin (“SR-2400” manufactured by Toray Dow Corning Corporation) was dissolved with an organic solvent (toluene) of five times as much as this silicone resin, to prepare coating treatment solution. Next, this coating treatment solution was sprayed onto the raw material powders moved by airflow, which is then dried at 180° C. for thirty minutes. As a result, the surface of each particle of the raw material powders was coated in the proportion of 100 mass% of the raw material powder to 1 mass% of the silicone resin (coating process), thereby obtaining coating treatment powders coated with the silicon resin.

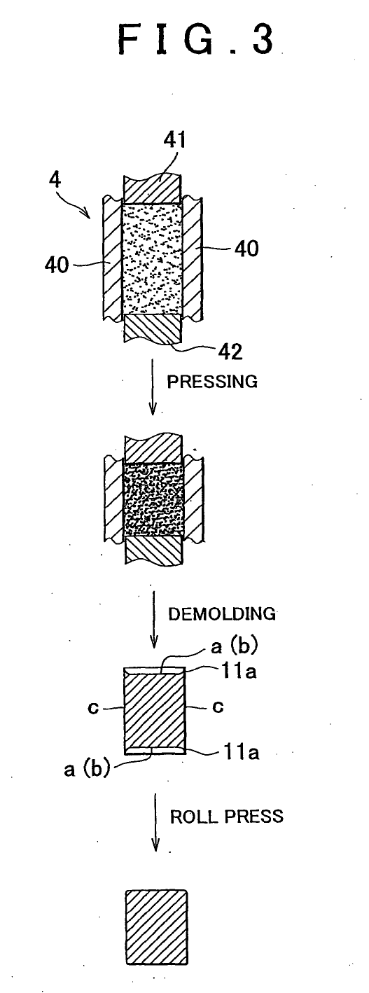

Next, a steel molding die shown in FIG. 3 was prepared. This die 4 is configured by a cylindrical fixed die 40, and an upper die 41 and lower die 42 that are capable of moving vertically within the fixed die 40.

Next, 20 parts by mass of lithium stearate having an average diameter of 20 μm and a melting point of approximately 225° C., 1 part by mass of a surfactant (polyoxytehylene nonyl phenyl ether), 1 part by mass of a surfactant (“borate ester emulbon T-80″ manufactured by Toho Chemical Industry Co., Ltd.), and 0.2 parts by mass of antifoam agent (“FS antifoam 80″ manufactured by Dow Corning Corporation) were dispersed in 10 parts by mass of distilled water to prepare dispersion liquid. This dispersion liquid was milled for 100 hours by using a ball mill in which a ball coated with fluorine resin is used. Thereafter, the generated liquid was diluted by 20 times using the distilled water to prepare diluted solution.

This diluted solution was applied to a mold surface of the die 4 by using a spray gun. As a result, the mold surface of the die 4 that forms a molded cavity was applied evenly with the lithium stearate.

The die 4 applied with the lithium stearate was heated by a heat at 120° C. to 150° C., and then a predetermined amount of the abovementioned coating treatment powders heated previously at 120° C. to 150° C. was charged into this cavity. While keeping the temperature of the die 4 at 120° C. to 150° C., the upper die 41 and lower die 42 were moved and brought close to each other as shown in FIG. 3, to perform compacting thereon at a molding pressure of 950 MPa to 1568 MPa. After being demolded, the obtained product was subjected to heat treatment in a nitrogen gas atmosphere at 750° C. for 30 minutes, in order to remove distortion.

Here, each rectangular solid core 11 is subjected to compression molding so that a planar surface surrounded by sides (a) and sides (b) shown in FIG. 2 forms a planar surface (press surface) pressed by the upper die 41 and the lower die 42. Therefore, in the obtained compact, burrs 11a are formed on the sides (a) and sides (b), but not on sides (c), as shown in FIG. 3.

The burrs 11a were pressed by a roll with a smooth surface to chamfer the sides (a) and sides (b) by means of plastic forming. The burrs 11a (edge parts) on the sides (a) and sides (b) were pressed by the rotary roll under dry conditions, without using cutting oil or coolant. The Fe-Si particles on the edge parts were metallurgically bonded with one another by friction heat.

Note that the greater the width of chamfer, the lower the electrical resistance. Therefore, the width of chamfer is set at C0.5 mm or lower, in consideration of the permissible range in which the product characteristics can be satisfied. Note that this chamfering process is for chamfering an intersecting section at 45 degrees. For example, when chamfering a part 1 mm away from each of the intersecting ends, this part is denoted by C1.

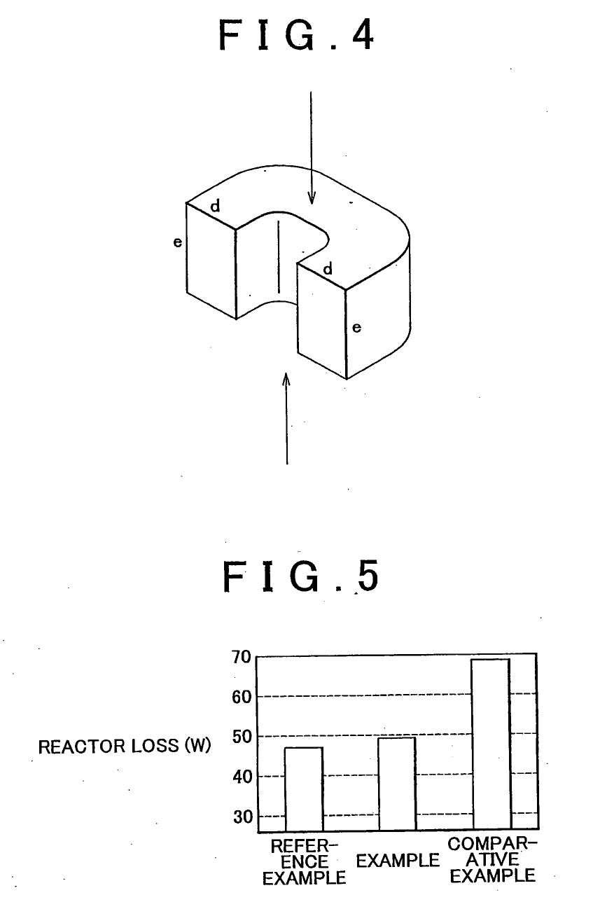

The circular cores 10 were molded according to the molding method used for the rectangular solid cores 11, except that the directions show by the arrows in FIG. 4 were taken as compression directions. The burrs of each leg part 101 are formed on upper and lower sides (d) only, but not on right and left sides (e). Therefore, the plastic forming was performed only on the sides (d) by using the roll.

Thus obtained circular cores 10, rectangular solid cores 11 and gaps 12 were disposed in the manner shown in FIG. 2 and adhered together using an epoxy adhesive to obtain the toroidal reactor device of the present example. In this reactor device, a magnetic flux penetrates the planar surface of each rectangular solid core 11 that is surrounded by the sides (a) and sides (c), and a magnetic flux penetrates the planar surface of each circular core 10 that is surrounded by the sides (d) and (e).

The powders on the sides (a) of the rectangular solid core 11 and the sides (d) of the circular core 10 are metallurgically bonded to one another by the plastic forming performed using the roll. Therefore, the insulation quality is low. However, the sides (c) of the rectangular solid core 11 and the sides (e) of the circular core 10 are remained as the compacts, and the Fe-Si particles keep high insulation quality. Therefore, when the magnetic fluxes penetrate, the generation of eddy current on the planar surface of the rectangular solid core 11 that is surrounded by the sides (a) and sides (c) and on the planar surface of the circular core 10 that is surrounded by the sides (d) and sides (e) is prevented.

The burrs that are formed during the molding are crushed by means of the plastic forming so that the insulation coating film of the coil 2 is not damaged. In addition, the change in the length of the gaps and the leakage of the magnetic fluxes can be prevented. As a result, a high-performance reactor device can be obtained.

### Reference Example

The circular cores 10 and the rectangular solid cores 11 were formed in the same manner as in the example, except that the plastic forming using the roll was not performed. A reactor device was also manufactured in the same manner as in the example. Because this reactor device does not have a section where powders are bonded metallurgically, the generation of eddy current is already prevented. However, the burrs 11a remain on the sides (a) and sides (b) of each rectangular solid core 11 and on the sides (d) of each circular core 10, the insulation coating film of the coil 2 might be damaged. Moreover, the length of the gaps might be changed by the Fe-Si particles falling off the burrs, or the jigs might be damaged.

### Comparative Example

The circular core 10 and the rectangular solid cores 11 were formed in the same manner as in the example, except that the planar surface surrounded by the sides (a) and the sides (c) is formed into the press surface when molding each rectangular solid core 11. A reactor device was also manufactured in the same manner as in the example. In this reactor device, the burrs are formed on the entire periphery of the planar surface of the rectangular solid core 11 that is surrounded by the sides (a) and sides (c), and the Fe-Si particles are bonded to one another metallurgically on the entire periphery by the plastic forming. In addition, the magnetic flux penetrates the planar surface of the rectangular solid core 11 that is surrounded by the sides (a) and sides (c). Therefore, eddy current is generated on the planar surface of the rectangular solid core 11 that is surrounded by the sides (a) and sides (c), increasing the reactor loss.

### Test Example

The reactor loss was measured on each of the reactor devices described in the above three examples in order to check the characteristics of the reactor device of the present example. The result is shown in FIG. 5. Note that the difference between input power and output power that is generated upon the operation of the reactor was taken as the reactor loss.

As shown in FIG. 5, the reactor device of the example has significantly lower reactor loss than the reactor device of the comparative example, and is equivalent to the reactor device of the reference example. This explains that the effect of preventing the generation of eddy current is achieved.

The reactor device of the invention can be used not only in a toroidal reactor device, but also in a stator core, anode reactor core, a rotor core, and the like.

While the invention has been described with reference to the example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A reactor device comprising:
a reactor core configured by a powder magnetic core; and
a coil wound around an outer periphery of the reactor core,
wherein the reactor core includes a pair of oppositely facing press surfaces formed by compression molding, a circumferential edge part of each of the press surfaces is plastically formed by pressure treatment, and the reactor core is disposed in a direction in which a magnetic flux generated upon energization of the coil does not penetrate each of the press surfaces.

2. The reactor device according to claim 1, wherein the reactor core has a toroidal shape and a plurality of gaps inserted thereto.

3. The reactor device according to claim 1, wherein the reactor core is plastically formed by pressing a roll having a smooth surface toward the edge part.

4. The reactor device according to claim 3, wherein the reactor core is formed by chamfering the edge part by performing the plastic forming.

5. The reactor device according to claim 4, wherein the width of chamfer of the reactor core is C0.5 mm.

6. (canceled)

7. A method for manufacturing a reactor device having a reactor core configured by a powder magnetic core, and a coil wound around an outer periphery of the reactor core, the method comprising:
plastically forming by pressure treatment a circumferential edge part of each of a pair of oppositely facing press surfaces of the reactor core that are formed by compression molding; and
disposing the reactor core in a direction in which a magnetic flux generated upon energization of the coil does not penetrate each of the press surfaces.
